(19) United States
(12) Patent Application Publication
(10) Pub. No.: US 2003/0076353 A1
(43) Pub. Date: Apr. 24, 2003

(54) Graphical user interface for collaboration

(76) Inventors: Michael A. blackstock, Coquitlam (CA); Barry Jinks, Vancouver (CA); Saxon Shuttleworth, Vancouver (CA); Henk Spaay, Vancouver (CA); Kori Inkpen, Belcarra (CA); Felix Lau, Vancouver (CA)

Correspondence Address: Robert E. Krebs, Esq., BURNS, DOANE, SWECKER & MATHIS, L.L.P., P.O. Box 1404, Alexandria, VA, 22313-1404, US

(21) Appl. No.: 10/039,848

(22) Filed: Oct. 23, 2001

(51) Int. Cl. G09G 5/00

(52) U.S. Cl. 345/751; 345/759; 345/758

(57) ABSTRACT

A graphical user interface for the collaboration of participants is disclosed. The participants are located within an area and the graphical user interface is generated on a display of an electronic device. The graphical user interface comprises an area representation and at least one participant representation generated on the display. The participant representation allows a viewer of the display to quickly identify the participants in the area, as well as see information about each one. Furthermore, the graphical user interface may include information representations which allow a viewer to access information associated therewith.

### BACKGROUND OF THE INVENTION

1. Field of Invention

The present invention relates to graphical user interfaces and more particularly to a user interface which can depict vital information needed for collaboration among the participants of a meeting.

2. Status of the Prior Art

During a meeting, it is often necessary to present and exchange information between participants. Typically, this occurs by presenting information on a screen that the participants can view. The information may be presented by an overhead projector, video projector, slide projector, easel, etc . . . . A drawback to this type of presentation is that the information cannot be easily shared among users. For instance, if a presentation is made using a video projector, the participants are usually given paper copies of the presentation for note taking. However, this does not allow the participants to actively edit the presentation or to easily collaborate ideas. It is mostly a passive presentation with the participants as viewers. Another problem is that information shared during the meeting can be lost. For instance, notes and papers passed among participants may be discarded after the meeting.

Commonly, participants will want to share private information with only certain members of the meeting. This is typically accomplished by whispering between participants which can be distracting and rude to the other participants. Otherwise, the meeting will be stopped so that the private information can be shared between the participants.

With the advent of computerized networking, it is now possible to share information during a meeting. Specifically, if the meeting room is equipped with networking connections, a participant can use his or her laptop computer or hand-held device to interface with a common network. The network will allow the participants to share information between themselves with their electronic devices.

However, even though the users are connected to the same network, it is not always easy to share the information. The operating environment on the computer is not configured for simultaneously sharing information between users. It is often difficult to determine the participants on the network and how to share the information between them. Accordingly, it is not a very easy or productive method for information exchange.

Often times when a meeting is held with a large group of people, nametags are often used to identify participants. Alternatively, namecards are placed in front of participants for identification. Sometimes a participant will place business cards in front of himself or herself at the locations of the other participants in order to remember names. However, nametags and namecards may be difficult to read. Business cards and namecards may shift out of order when papers are passed around or become lost. After the meeting, the names of the people met may be sorted alphabetically instead of associated with the participants of the meeting. This makes it difficult for a participant to remember the other participants. Furthermore, after a meeting namecards are picked up and discarded thereby not saving any information about participants.

The present invention addresses the above-mentioned deficiencies of collaboration at meetings by providing a method of identifying participants and sharing information using electronic devices equipped with a graphical user interface that permits collaborative exchanges. More specifically, the present invention provides for a method of graphically displaying meeting information on an electronic device such as a Personal Digital Assistant (PDA) or laptop computer which enables participants to collaborate quickly and easily on projects as well as provide identification information to all participants. Furthermore, the present invention provides a system and method for saving participant information for quick and easy retrieval at a later time. It is also possible to save the information exchanged during the meeting with the present invention.

### SUMMARY OF THE INVENTION

In accordance with a preferred embodiment of the present invention, there is provided a graphical user interface for the collaboration of participants located within an area. The graphical user interface is for a display on an electronic device and comprises an area representation generated on the display. The user interface further includes at least one participant representation generated on the display. The participant representation and the area representation allow a viewer of the display to quickly identify the participants of the meeting. Typically, the area representation is generated according to the physical characteristics of the area and the participant representation is generated on the display at an approximate location of the participant. Furthermore, the graphical user interface may include a data representation that is operable to allow the viewer of the display to access information associated with participants, the area, devices or objects in the area.

The graphical user interface may be divided into a shared area and a private area. The shared area is operative to provide information to all viewers of the graphical user interface and the private area is operative to provide information only to selected participants. The electronic devices of the participants may be in communication with one another in order to share information. The electronic device may be a PDA, cellular phone, computer or other electronic device capable of sending and receiving information via a network.

In accordance with the present invention there is provided a method of providing collaborative information to participants of a meeting. Each of the participants will have an electronic device with a collaboration graphical user interface. The method comprises networking the electronic devices of the participants in order to share information therebetween. Next, identity and location information for at least one participant is determined. Finally, the entity information is displayed with the graphical user interface on at least one electronic device. In this respect, a viewer of the graphical user interface will be able to see identity information and the location of the member of the group.

It will be recognized that identity information for all participants can be determined and displayed. Because the electronic devices are networked together, this information can be displayed on all of the graphical user interfaces of the electronic devices for sharing and collaboration.

### BRIEF DESCRIPTION OF THE DRAWINGS

These, as well as other features of the present invention will become more apparent upon reference to the drawings wherein:

FIG. 1 is a diagram of a graphical user interface constructed in accordance with the present invention and showing the location of participants and information;

FIG. 2 is a diagram of a graphical user interface constructed in accordance with the present invention and showing the relative location of participants and information on a hand-held computer;

FIG. 3 is a diagram of a simplified graphical user interface constructed in accordance with the present invention and showing the relative location of participants;

FIG. 4 is a flowchart showing a method of manually generating identity information for the graphical user interface of the present invention;

FIG. 5 is a flowchart showing a method of automatically generating identity information for the graphical user interface of the present invention;

FIG. 6 is a diagram showing how devices in a location locate one another;

FIG. 7 is a flowchart showing how identity information may be automatically requested and received directly;

FIG. 8 is a flowchart showing how identity information is automatically requested and received using an access point and server;

FIG. 9 is a diagram showing how devices in a location communicate through a server;

FIG. 10 is a diagram showing a participant information page; and

FIG. 11 is a diagram showing a participant chat screen.

### DETAILED DESCRIPTION OF THE PREFERRED EMBODIMENTS

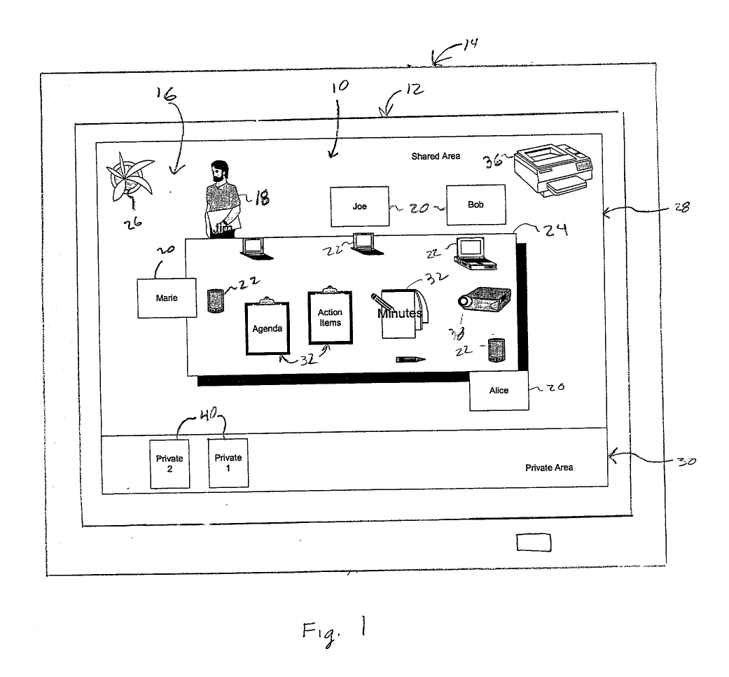

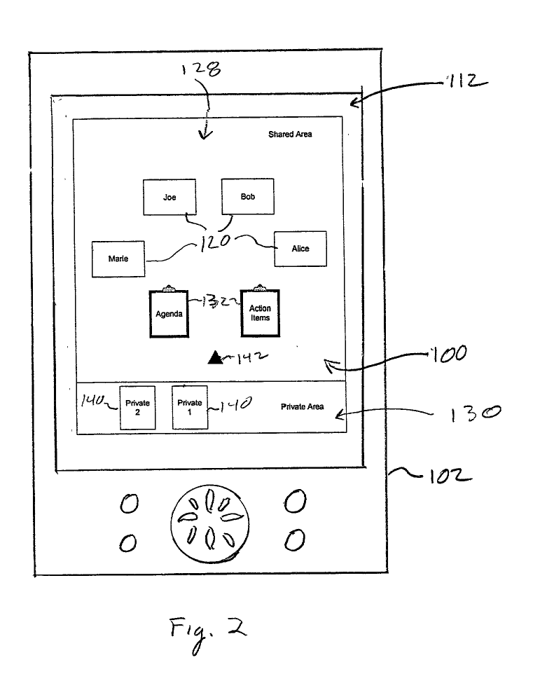

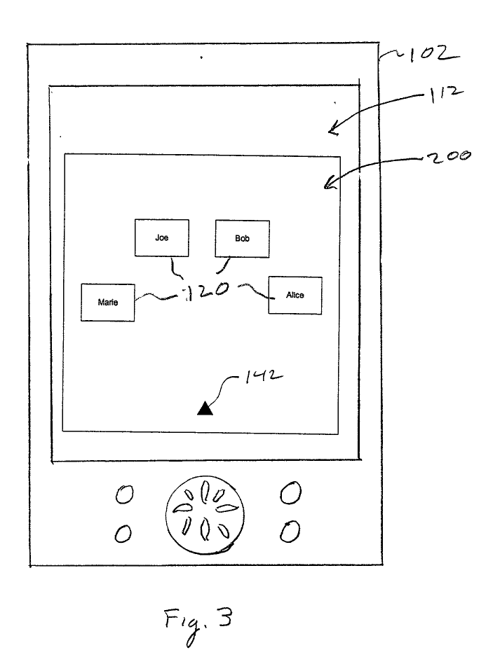

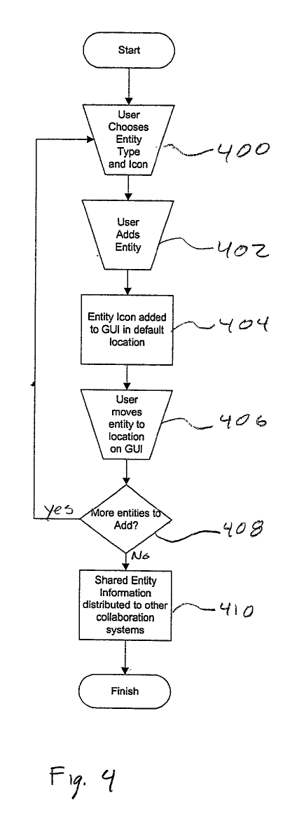

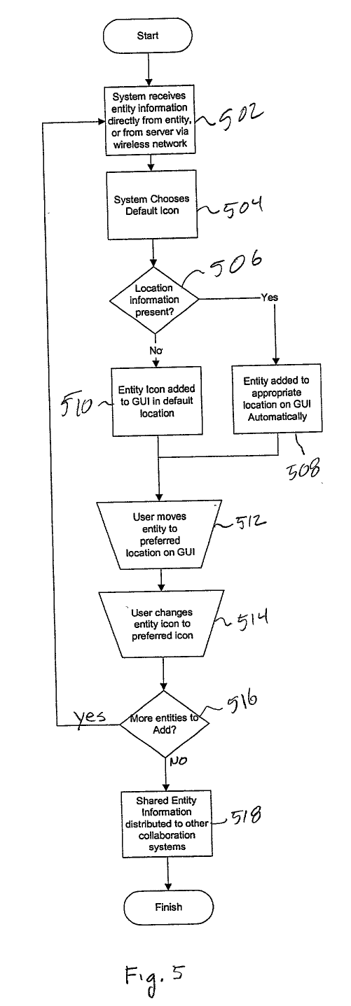

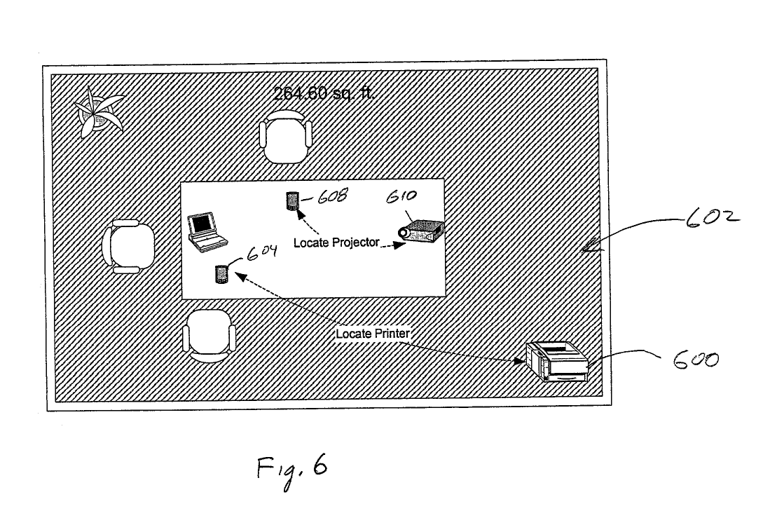

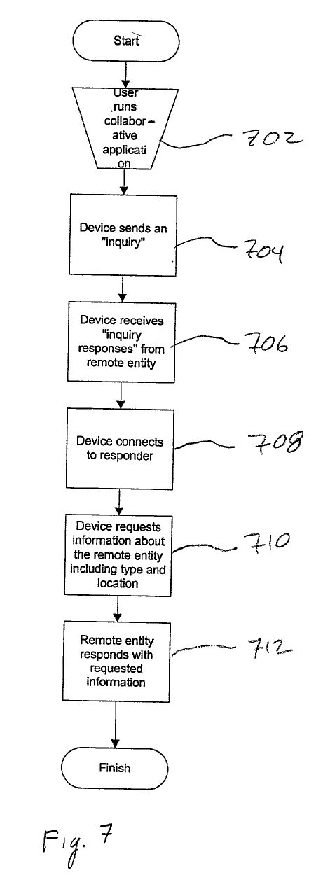

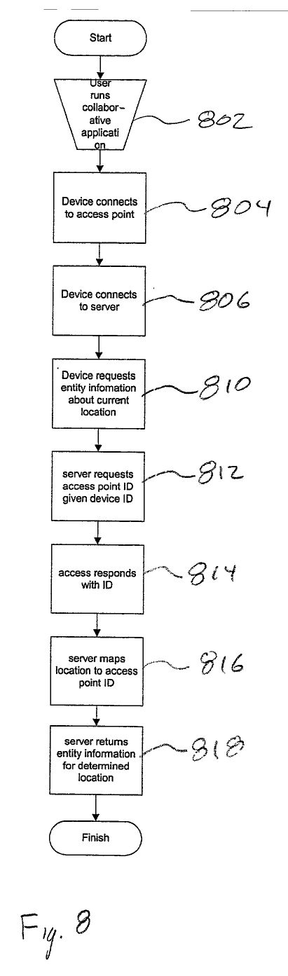

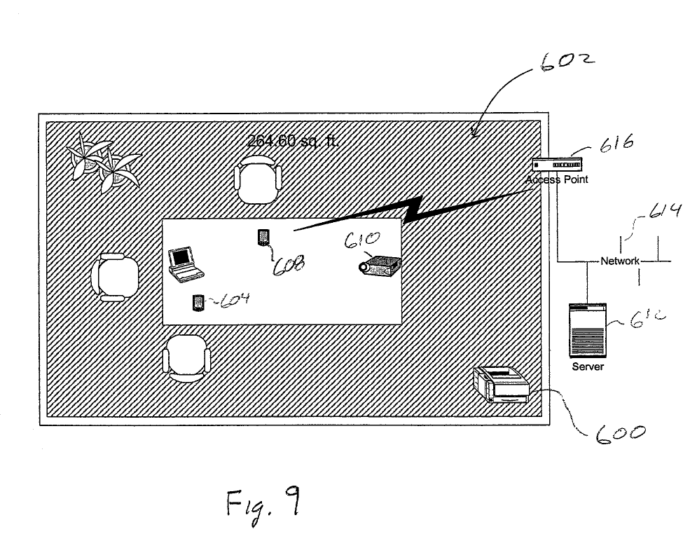

Referring now to the drawings wherein the showings are for purposes of illustrating preferred embodiments of the present invention only, and not for purposes of limiting the same, FIG. 1 shows a graphical user interface (GUI) 10 for allowing the collaboration of participants in a meeting. The GUI 10 can be presented on a display 12 of a monitor 14. A computer such as a laptop computer generates the GUI 10 with software programmed thereon. The software is capable of generating the GUI 10 through commonly recognized programming techniques.

The GUI 10 is used to facilitate the transfer and organization of information between the participants in a meeting. In this sense, the participants of the meeting will each have an electronic device that is capable of running the software that generates the GUI 10. As will be further explained below, the electronic device may not only be a laptop computer, but could be a PDA, cell phone, or hand-held computer running the GUI application software.

Referring to FIG. 1, the GUI 10 of the present invention is a visual representation of the participants, physical location, electronic devices, projection devices and other items ordinarily present during a meeting. The GUI 10 can simulate the contents of a room, as well as provides the opportunity for collaboration between participants. For instance, the GUI 10 may generate a simulated room 16 where the meeting is taking place. The simulated room 16 may have dimensions similar to the actual room that the meeting is taking place in order to provide a recognizable environment. Placed within the simulated room 16 will be representations of the participants, furniture, electronic devices, shared areas and private areas. For example, in order to orientate the participants with the view depicted by the GUI 10, a table 24 may be generated in the approximate location of the table within the real room. Furthermore, a plant 26 may be generated on the GUI 10 in the location that the plant is situated in the room. Accordingly, the simulated room 16 may include some the features of the real room.

The GUI 10 can be segregated into two areas. The first area is a shared area 28 which is viewed by all the participants of the meeting. The second area is a private area 30 which can only be viewed by certain members of the meeting. The shared area 28 provides an area where all members of the meeting can transfer and view common information. In this regard, the shared area 28 provides an interactive meeting space for the participants of the meeting to view action items, minutes, the agenda, personal information about the participants and to control presentation devices such as printers and projectors. On the other hand, the private area 30 is dedicated for sharing information among selected participants of the meeting. The private area 30 permits selected members to transfer information among themselves without sharing the information with the whole group. As will be further explained below, the GUI 10 allows collaboration between members of the meeting and often times, only certain participants will wish to share information. The private area 30 allows these members to privately share information among themselves. The private area 30 may further be divided into different subgroups for the different participants of the meeting. This would enable participants to collaborate with other members in their own private subgroups. The private area 30 can also allow an individual to keep information private to himself or herself through the use of individual private areas.

Alternatively, information that is transferred and shared with the GUI 10 can be tagged as “private” or “shared” in order to control access. For example, documents or contact information may be designated as being viewable by all users. In this case, the information is tagged as “shared” information which is similar to being placed in the shared area 28. Alternatively, information may be tagged as being “private” which limits access to the information to designated participants. Information that is tagged as being “private” is similar to placing the information in private area 30.

The GUI 10 may include at least one participant icon 18 which represents a participant in the meeting. The participant icon 18 may be a photograph of the participant, a business card icon 20, a graphical representation of the participant, or any other type of icon that can depict the participant. As seen in FIG. 1, the participant icon 18 may be positioned within the simulated room 16 by the GUI 10 at the physical location of the participant. In other words, the location of the participant icon 18 in the simulated room 16 can mirror the location of the participant in the real meeting room. It is often easier to remember a person's name at a later time by remembering attendees and their location. The GUI 10 can be saved with the identity and location of the participants in order to remember their names more easily.

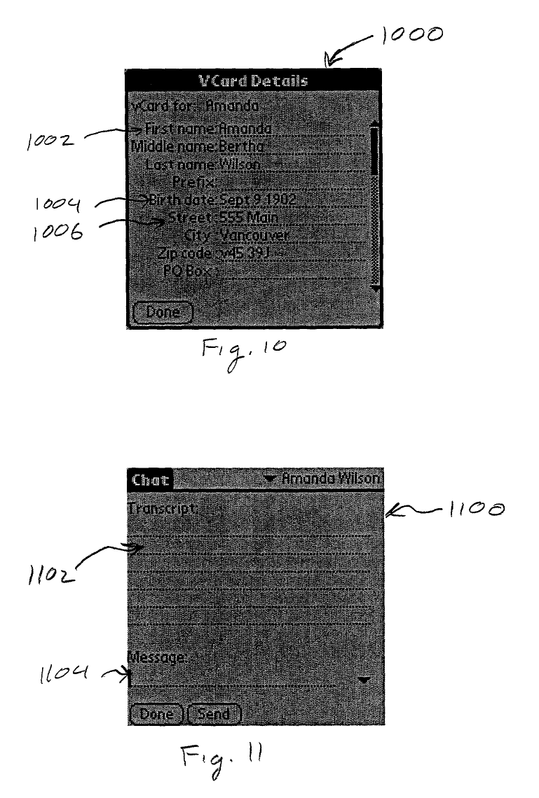

Business card icons 20 are placed at the corresponding location of each participant and function similarly to participant icon 18. The business card icons 20 include a label which identifies each participant. The labels may be the names of the participant. As seen in FIG. 1, the business card icons 20 are placed around the table at the corresponding location of each of the participants. Each of the business card icons 20, as well as the participant icon 18, may be used to access information about the participant, as well as to communicate with him or her. For instance by selecting (i.e., double clicking) the business card icon 20 labeled “Joe”, the user can access a personal information page 1000 (FIG. 10) on his or her display. The personal information page, as seen in FIG. 10, could include such information as the participant's name 1002, address, birth date 1004, address 1006, etc . . . . The personal information may be imported from a contact manager for ease of use or be integrated within the software which creates the GUI 10. Additionally, the personal information page may include a way for the user to communicate with other users or add notes about the user or their actions during the meeting. For instance, FIG. 11 depicts a representative chat screen 1100 that is accessible through the participant icon 18. The chat screen 1100 allows participants to collaborate while the meeting is taking place. Participants who are involved in the chat will see a transcript 1102 of the chat. A message area 1104 allows the participant to send his or her message to other participants. The chat screen 1100 can be configured to send private messages to selected participants or to all participants of the meeting.

The GUI 10 will be configured to display the locations of the participants and other items in the room relative to the participant viewing his or her respective display. Referring to FIG. 1, the GUI 10 is also able to display the type of electronic device that each participant is using by a device icon 22. Each device icon 22 shows the type of device the participant is using such as a PDA in the case of Marie and Alice, or a laptop computer as shown for Joe and Bob. The device icon 22 allows the viewer of the GUI 10 to know the capabilities of the other participants devices. As will become evident below, the electronic device that the GUI 10 is generated on can affect the type of information that will be displayed. A participant using a PDA may not be able to view the same type of information that a participant using a laptop computer can. Therefore, when transferring information between participants, it is advantageous for each participant to know the capabilities of the other participant's electronic device. The GUI 10 is therefore operable to show information about the participants and the devices used during the meeting for collaboration.

The GUI 10 may further include icons representing documents to be used in the meeting. Referring to FIG. 1, the GUI 10 includes document icons 32 which are used to access the items labeled therewith. For the example shown in FIG. 1, the document icons 32 are used to view the agenda, minutes or action items for the meeting. If a viewer of the GUI 10 wishes to view the agenda at any time during the meeting, then the viewer would select (i.e., click on) the document icon 32 labeled “Agenda”. Similarly, if the viewer wishes to see the action items, the view would select the document icon 32 labeled “Action Items”. The appropriate document would then be accessed and displayed on the participants electronic device via the software for the GUI 10 or other type of display software. The document icons 32 can be used to signify the type of documents that are viewable. For instance, the document icon 32 may look like a clipboard to show that the document is viewable with a clipboard viewer. Alternatively, the clipboard icon 32 may be a spreadsheet to show that the document is viewable with a spreadsheet program. Accordingly, the representation of the document icon 32 can show the type of document.

As previously mentioned, the GUI 10 can be displayed on both PDA's and computers. Depending upon the device and the document attributes, the document accessed by the document icon 32 may or may not be able to be displayed on the user's device. For instance, if the participant is using a PDA, he or she may not be able to view a spreadsheet due to the limited processing capability and memory size of the PDA. In such a case, the GUI 10 might display a message informing the participant that the item cannot be viewed. However, a participant using a computer might be able to view the document. The documents accessible by the document icons 32 may be stored on a network accessible by all devices, or the devices may be able to communicate in a peer-to-peer network for sharing of documents. The GUI 10 is not dependent on the type of network that is used for accessing and sharing information.

In order to print documents using the GUI 10, a printer icon 36 is used. The printer icon 36 can be used to access the features of a printer that is in the meeting room. Additionally, the GUI 10 may be programmed to have a user drag and drop a document to the printer icon 36 in order to print that document. For instance, a document icon 32 may be dragged to the printer icon 36 for printing that document.

Similarly, the GUI 10 may include a projection device icon 38 which represents a display projector located within the meeting room. The projection device icon 38 can control the operation of the projector. The GUI 10 may be programmed to run a particular presentation when the participant drags the presentation to the projection device icon 38. For example, the minutes for the meeting may be displayed by the projector by dragging the document icon 32 labeled “minutes” to the projection device icon 38. The projector will then display the minutes on a screen for all participants to view.

As previously mentioned, the GUI 10 is segregated into a shared area 28 and a private area 30. The shared area 28 is viewed by all participants of the meeting. All of the information and features available in the shared area 28 may be used by all the participants. On the other hand, the private area 30 provides a collaboration area for only authorized participants. The private area 30 contains privacy icons 40 which are only accessible to authorized participants. The privacy icons 40 can designate private rooms for the sharing of collaborative information such as documents and notes. For example, by selecting the privacy icon 40, the participant will be directed to a file list of accessible documents. However, if the participant is not allowed to view those files, he or she will not be directed to the file list and instead be given a message that access is unauthorized. Each privacy icon 40 can be configured to allow access only to designated members of the group. It will be recognized that security may be increased by including a password that must be entered after the participant selects the privacy icon 40. Additionally, security may be enhanced by configuring the GUI 10 to only allow certain participants the access to modify and configure the contents selected by respective privacy icons.

The private area 30 may be divided into separate private areas for different subgroups of the meeting. This would allow participants to only view the private documents for the subgroup that they are a member. It will be recognized that the private area 30 may include a personal private area that the viewer of the device can use for storing and retrieving personal information that is not accessible to other participants. Furthermore, the GUI 10 can be configured that privacy icons 40 are only viewable on devices that the participant has been granted access.

Referring to FIG. 2, a simplified GUI 100 is shown on a PDA 102. The simplified GUI 100 is minimized in content in order to run on the limited processing and memory capabilities of the PDA 102. The GUI 100 is generated on a display 112 of the PDA 102 and functions similarly to the GUI 10 shown in FIG. 1.

The GUI 100 has a shared area 128 and a private area 130. Generated within the shared area 128 are business card icons 120 which are placed in the relative positions of the participants of the meeting. Each of the business card icons 120 are similar to the business card icons 20 described for FIG. 1. Accordingly, each business card icon 20 can provide information about the participant in the meeting, as well as their location relative to a viewer of the GUI 100. As seen in FIG. 2, each business card icon 120 is labeled with a name of the participant (i.e., “Joe”, “Alice”, “Bob”). By selecting the business card icon 120 with the appropriate device (i.e., stylus), the information about the participant will be presented on the display 112 of the PDA 102. The configuration of the GUI 100 can be saved for later retrieval to help remember the names and faces of the participants via their locations in the room.

As previously mentioned, the business card icons 120 can provide positioning information about the participants to the viewer of the GUI 100. The GUI 100 will include a locator icon 142 that indicates location of the viewer of the GUI 100. The user of the GUI 100 can then place the business card icons 120 on the GUI 100 in the location of the respective participants of the meeting. Typically, the icons can be placed by dragging them with the stylus of the PDA 102 or they may be auto-located, as will be further explained below.

The GUI 100 can also include document icons 132 which are used for displaying and editing documents. Each of the document icons 132 are similar to the document icons 32 described for FIG. 1. In this regard, each icon 132 is labeled with the name of the document and when the document icon 132 is selected that document can be presented on the display 112 of the PDA 102 for viewing and/or editing.

As previously mentioned, the GUI 100 includes a private area 130 for the transfer of private information between selected participants of the meeting. The private area 130 is similar in function to the private area 30 described for FIG. 1. In this regard, the private area 130 includes privacy icons 140 that are only accessible to previously authorized participants. The information selected by the privacy icons 140 can be shared between members of the group via a wireless or wired network, as will be explained below. The privacy icons 140 will only allow authorized members to view the documents or files corresponding the respective privacy icon 140.

Even though the GUI 100 has been described as operating on a PDA 102, it will be recognized that the GUI 100 can also be displayed on a computer monitor such as display 12. The GUI 100 can be configured to run on any type of electronic device such as a computer or laptop computer. It is not limited only to a PDA 102.

Referring to FIG. 3, a simplified GUI 200 is shown. The simplified GUI 200 is used only for displaying information about the participants in the meeting. For instance, the simplified GUI 200 will include business card icons 120, as well as locator icon 142. The business card icons 120 are positioned on the GUI 200 in the locations of the participants relative to the viewer of the GUI 200 as represented by locator icon 142. In this respect, the GUI 200 functions similarly to the GUI 100 shown and described in FIG. 2. However, the GUI 200 may not be able to access documents or other information that is to be shared between participants due to device limitations. Accordingly, the GUI 200 does not include document icons 132, a private area 130 or a shared area 128.

Referring to FIG. 4, the method for adding icons to the GUI 10 is shown. Even though, the following explanation for adding icons to the GUI 10 is being described, it will be recognized that the explanation for adding icons also applies to the GUI 100 and the GUI 200. Additionally, it is possible to add icons and information related to data, local landmarks, people and devices using a tool bar, template, menu command or other means.

In order to add an icon to the GUI 10, the user first chooses the entity type and the icon in step 400. For instance, the user will choose whether a participant, document, or device is being represented. Next, the user will decide the type of icon to represent the entity. For example if a participant is being represented, the user can choose to represent the participant with a business card icon 20 or a participant icon 18. The user can choose icons from clip art or other sources. After the user has chosen the entity type and the representative icon, the user will add the entity to the GUI 10 in step 402.

After the entity has been added, the GUI 10 will position the icon in a default location, as shown in step 404. After the icon as been added to the GUI 10, the user is able to move the icon to the correct position on the GUI 10 in step 406. For instance, if the icon represents a participant, the user can move the icon to the relative position of the participant in the meeting room thereby allowing the user to have a visual reference of the location of the participant relative to the user. Alternatively, the user can move the icon to any location on the display 12 that is convenient.

If more entities are to be added to the GUI 10, then step 408 will repeat steps 400 to 406 until all the desired entities are added. The user will then be able to add more participants, devices, documents, etc . . . . After all the entities have been added to the GUI 10, then any information that is to be shared between the participants will be distributed to other collaboration systems, as seen in step 410. The electronic device that the GUI 10 is displayed on can transfer information to other devices located in the meeting area through a network for sharing and collaborating. As such, the information that the user adds to the GUI 10 can be shared with other devices connected to the network through common networking techniques.

Additionally, by sharing information with other collaboration systems, the GUI 10 displayed on other electronic devices will be automatically or manually updated by request. For example, the entity information and the icon of the participant will be displayed on the other GUI's 10 once the user adds the entity in step 402. When the user moves the icon in step 406, the icon will move on the other displays 12 that are in the network. Therefore, it is possible to share information with the group. The information can also be saved on a common database so that it can be indexed and retrieved later. The information can be indexed by keywords, attendees, time/date, and other attributes associated with the meeting for retrieval at a later time.

Referring to FIG. 5, a method for automatically entering entity information is shown. The method begins with step 502 by the system upon which the GUI 10 is installed receiving entity information directly from the entity or from a server via a wireless network. Some entities like network printers and computers can share information about themselves directly to the system. Referring to FIG. 6, printer 600 located in room 602 may be a network printer which can provide information directly to the device 604. Similarly, projector 610 can share information to device 608. Typically, the entity will provide information regarding the type of device and its location. In step 504, the system will choose a default icon for the entity. The default icon may be chosen using the identity information provided in step 502.

Next, in step 506, the system determines if location information was provided by the entity. If location information is present, then in step 508, the entity is added to the appropriate location on the GUI 10 according to that information. However, if location information is not provided, then the entity is added to the GUI 10 at the default location in step 510.

Once the entity has been added to the GUI 10, then the user has the option of moving the icon to a preferred location in step 512. Referring to FIG. 6, the user of the electronic device 604 can locate the printer 600 to a preferred location. Similarly, the user of electronic device 608 can locate the projector 610 to a preferred location. It is possible for the user to control the location of the icons in order to customize the look of the GUI 10. Similarly, in step 514, the user has the option to change the icon for the entity that has just been added. This is necessary if the icon that was chosen by the system is not correct, or if the user wishes to change the look for personal reasons.

Once the icon has been added for the entity, then it is determined whether there are more entities to be added to the GUI 10 in step 516. If there are more entities to add, then steps 502 to 516 are repeated. However, if there are no more entities to be added, then in step 518, the shared entity information is distributed to the other collaboration systems in the network.

Referring to FIG. 7, a method for receiving identity information from an entity is shown. The method begins in step 702 when the user runs the collaborative application that generates the GUI 10 on his or her electronic device. Next, in step 704, the device that the application is being run on will send an inquiry to the other devices in the network in order to receive information. The inquiry can be performed automatically or manually, as desired. Each of the devices will respond with an inquiry response to the sending device in step 706. Next, in step 708, the device will connect to a responder of the system in order to communicate with the other devices. Once connected to the responder, the device will request identity and location information from the other devices in the network in step 710. The identity and location information is used by the collaborative application to choose the appropriate icon and to place it in the correct location on the GUI 10. The remote entities in the network will respond with the requested information to the device in step 712 such that the information can then be displayed on the GUI 10.

FIG. 8 is a flowchart depicting an alternative method for automatically identifying information from an entity. In step 802, the collaborative application which generates the GUI 10 is run on a device 608, as shown in FIG. 9. Next, in step 804 of FIG. 8, the device is connected to an access point 616 of network 614. The access point 616 may be an Ethernet hub, wireless access point such as those used for Bluetooth or wireless Ethernet. If the access point 616 is for a wired network, then the location may be known. The location of static devices such as printers could be manually entered into the server. The location of access points could also be stored in the server. When a mobile device uses the access point, the location of the mobile device will correspond approximately to the location of the access point. Accordingly, it is possible to determine an approximate location of the mobile device via the access point that the mobile device is contacting. If the access point is for wireless devices, it is still possible to determine an approximate location for the mobile device. For instance, if the access point is a Bluetooth access point, the mobile device must be within a prescribed distance for proper operation.

Once the device has connected to the access point 616, the device will then connect to the server 612 through network 614 as shown in step 806 of FIG. 8. Once the device is connected to the server 612, the device will request entity information about its current location in step 810. Specifically, device 608 will inquire from access point 616 its location. In step 812, the sever 612 will then request the access point identification for the given device 608 connected thereto. The access point 616 will return device 608 and the access point 616 identification and location information to the server 612 in response, as seen in step 814. With the identification and location information, the server 612 will then be operable to map the location of the device 608 to the location determined by the access point 616, as shown in step 816. The server 612 will be able to store the entity location and information for later retrieval and sharing with other devices connected to the network 614. The server 612 will be operable to return the entity information to the device 608 in step 818. Accordingly, the server 612 is able to store and transfer location and identity information about all the entities in the network 614 to each electronic device. As previously mentioned, the entity and location information will be presented on each GUI 10 in order to show the relative locations of entities in the meeting room. The location of printers and other non-portable objects in the room can also be stored on the server for later retrieval.

Additional modifications and improvements of the present invention may also be apparent to those of ordinary skill in the art. Thus, the particular combination of parts described and illustrated herein is intended to represent only certain embodiment of the present invention, and is not intended to serve as limitations of alternative devices within the spirit and scope of the invention.

1. A graphical user interface for a display of an electronic device and used for the collaboration of participants located within an area, the graphical user interface comprising:
an area representation generated on the display; and
at least one participant representation generated on the display corresponding to a respective one of the participants;
wherein the participant representation allows a viewer of the display to quickly identify the participants in the area.

2. The graphical user interface of claim 1 wherein the area representation is generated according to the physical characteristics of the area and the participant representation is generated on the display at an approximate location of the participant.

3. The graphical user interface of claim 1 further comprising a data representation generated on the display, the data representation allowing a viewer to access information associated therewith.

4. The graphical user interface of claim 3 wherein the data representation is configured to allow participants to share the information associated therewith.

5. The graphical user interface of claim 1 further comprising a device representation generated on the display, the device representation allowing a viewer to control the device associated therewith.

6. The graphical user interface of claim 1 further comprising a shared area and a private area, the shared area being operative to provide information to all viewers of the graphical user interface and the private area being operative to provide information only to selected participants.

7. The graphical user interface of claim 1 wherein the participant representation is an icon that corresponds to the participant.

8. The graphical user interface of claim 1 wherein the electronic devices of the participants are in communication with one another and the graphical user interface is configured to share information between the devices.

9. The graphical user interface of claim 8 wherein the graphical user interface is configured to transfer information between devices in wired communication with each other.

10. The graphical user interface of claim 8 wherein the graphical user interface is configured to transfer information between devices in wireless communication with each other.

11. The graphical user interface of claim 8 wherein the area representation and the participant representation are configured to be displayed on a device selected from the group consisting of:
a computer;
a personal digital assistant; and
a cell phone.

12. A method of providing collaborative information to participants of a meeting, each of the participants having an electronic device with a collaboration graphical user interface (GUI), the method comprising the steps of:
a) networking the electronic devices of the participants in order to share information;
b) determining entity information for at least one participant; and
c) displaying with the GUI the entity information on at least one electronic device.

13. The method of claim 12 wherein step (a) comprises networking the devices with a wireless network.

14. The method of claim 12 wherein step (a) comprises networking the devices with a wired network.

15. The method of claim 12 wherein the electronic device is selected from the group consisting of:
a computer;
a personal digital assistant; and
a cell phone.

16. The method of claim 12 wherein step (b) comprises determining entity information automatically from the electronic device of the participant.

17. The method of claim 12 wherein step (b) comprises determining entity information comprising biographical data about the participant.

18. The method of claim 12 wherein step (b) comprises determining entity information regarding information to be shared with the participants.

19. The method of claim 12 wherein step (c) further comprises displaying the entity information with the GUI on all of the devices connected in the network.

20. The method of claim 19 wherein the GUI is divided into a shared area and a private area and step (c) comprises displaying the entity information in the shared area which is viewable by all the participants.

21. The method of claim 19 wherein the GUI is divided into a shared area and a private area and step (c) comprises displaying the entity information in the private area which is accessible to only authorized participants.

22. A method of generating a collaborative graphical user interface on a display of an electronic device, the method comprising the steps of:
a) determining entity information of participants located within an area;
b) determining location information of the participants located within the area; and
c) generating a representation for each of the respective participants on the display of the electronic device in their respective locations within the area.

23. The method of claim 22 wherein steps (a) and (b) are performed automatically by the electronic device.

24. The method of claim 22 wherein the electronic devices are in communication with one another and the method further comprises the step of sharing entity and location information between the electronic devices.

25. The method of claim 24 further comprising the step of generating a document representation on the display corresponding to documents which can be shared between electronic devices.

26. The method of claim 25 further comprising the step of generating a private area and a shared area or the display in order to control access to the information.
